(19) United States
(12) Patent Application Publication
(10) Pub. No.: US 2009/0172516 A1
(43) Pub. Date: Jul. 2, 2009

(54) Providing Enhanced Information When a Pointing Device Points to a Specific Area In a Graphical User Interface

(75) Inventor: Bikram Singh Gill, Mohali (IN)

Correspondence Address: LAW FIRM OF NAREN THAPPETA, C/o Landon-IP Inc.,, 1700 Diagonal Road, Suite 450, Alexandria, VA, 22314, US

(73) Assignee: Oracle International Corporation, Redwood Shores, CA (US)

(21) Appl. No.: 12/031,700

(22) Filed: Feb. 14, 2008

(30) Foreign Application Priority Data
Jan. 2, 2008 (IN) 16/CHE/2008

(51) Int. Cl. G06F 17/21; G06F 3/048

(52) U.S. Cl. 715/228; 715/808

(57) ABSTRACT

Providing enhanced information when a pointing device points to a specific area in a graphical user interface. In one embodiment, on receiving an indication indicating that the pointing device is pointing to a specific area on a display screen (displaying the graphical user interface) and that an input is received from an input device, a message corresponding to the input and the specific area is displayed on the display screen. Further, on receiving a new input from the input device (with the pointing device pointing to the same specific area), a new message corresponding to the new input and the specific area is then displayed on the display screen.

### RELATED APPLICATIONS

The present application is related to and claims priority from the co-pending India Patent Application entitled, “Providing Enhanced Information When a Pointing Device Points to a Specific Area In a Graphical User Interface”, Serial Number: 16/CHE/2008, attorney docket number: ORCL-070/India, Filed: 2 Jan. 2008, Applicant: Oracle International Corporation, naming the same inventors Bikram Singh Gill as in the subject patent application, and is incorporated in its entirety herewith.

### BACKGROUND

1. Technical Field

The present disclosure relates to user interfaces and more specifically to providing enhanced information when a pointing device points to a specific area in a graphical user interface.

2. Related Art

A graphical user interface or GUI generally refers to a type of user interface, which allows users to interact with a digital processing system using graphical icons, menus, visual indicators or, in general, graphical elements (optionally associated with text) presented on a display screen.

The graphical elements may represent relevant information and allow a user to provide various types of inputs. Some of the inputs cause actions (such as opening an application, showing further information in the form of a menu, etc.) to be performed, as is well known in the relevant arts.

Pointing devices are often used in conjunction with GUIs. A pointing device generally enables users to indicate a desired location (e.g., on the area displaying a graphical element or any portion of the display screen) in a graphical user interface. A common example of a pointing device is a mouse, which enables a desired location to be specified by detecting two-dimensional motion relative to its supporting surface. Other examples of pointing devices include, but not limited to, touch pads, joysticks, etc.

The indication of a desired area (based on the location pointed by the pointing device) can be the basis for several further purposes. For example, a user may be required to select an appropriate graphical element using the pointing device for performing a desired action. As an illustration, the user may click at an area (displaying a text field) using a mouse and then provide character inputs using a keyboard. Alternatively, a user may click on a file icon (at the pointed area) and then drag the icon to a container icon (e.g., directory window) to cause the file to be copied to the corresponding container.

Enhanced information is often displayed with a pointed area, typically to make the interface more user friendly. Enhanced information refers to text (or any other understandable format, as suited for the specific environment) that is not present before the specific area is pointed to, but appears after the pointing device points to the specific area. Enhanced information provides helpful information as relevant to the specific context.

For example, in Windows family of operating systems provided by Microsoft Corporation, “tool tips” provide textual enhanced information as relevant to the specific graphical element pointed to by the pointing device. Similarly, in case of browser software, when a user points to a hyperlink, a snapshot of the corresponding webpage (identified by the hyperlink) is displayed as a image.

In general, it is desirable the user interfaces provide helpful information.

### BRIEF DESCRIPTION OF THE DRAWINGS

Example embodiments of the present invention will be described with reference to the accompanying drawings briefly described below.

FIG. 1 is a block diagram illustrating the details of a digital processing system in which various aspects of the present invention are operative by execution of appropriate software instructions.

FIG. 2 is a flowchart illustrating the manner in enhanced information is provided when a pointing device points to a specific area in a graphical user interface according to an aspect of the present invention.

FIG. 3A depicts a portion of a graphical user interface containing different graphical elements in one embodiment.

FIG. 3B depicts a portion of a graphical user interface in which a default message (without receiving an input) is displayed when a pointing device initially points to an area (graphical element) in one embodiment.

Each of FIGS. 3C-3E depicts a portion of a graphical user interface in which a message is displayed in response to corresponding inputs received from an input device, when the pointing device points to the same area (graphical element) in one embodiment.

FIG. 4A depicts a portion of a file indicating the messages corresponding to different inputs when a pointing device points to an area (graphical element) in one embodiment.

FIG. 4B depicts a portion of a file indicating the messages corresponding to different inputs and different areas (graphical elements) in one embodiment.

FIGS. 5A and 5B together depicts a portion of a software code (containing software instructions) which on execution provides enhanced information when a pointing device points to a specific area in a graphical user interface in one embodiment.

FIG. 6A depicts a portion of a web-based user interface containing information of interest in one embodiment.

FIG. 6B depicts a portion of a web-based user interface containing additional information of interest in one embodiment.

FIG. 6C depicts a portion of a web-based user interface enabling a user to select hidden information of interest to be displayed in one embodiment.

Each of FIGS. 6D and 6E depicts a portion of a web-based user interface in which additional/hidden information is displayed in response to corresponding inputs received from an input device, when the pointing device points to the same area (cell) in one embodiment.

FIG. 7A depicts a portion of a web-based user interface containing information of interest displayed in a visual manner (in the form of a graph containing graph objects) in one embodiment.

FIG. 7B depicts a portion of a web-based user interface in which additional information is displayed in a visual manner in response to corresponding inputs received from an input device, when the pointing device points to the same area (graph object) in one embodiment.

In the drawings, like reference numbers generally indicate identical, functionally similar, and/or structurally similar elements. The drawing in which an element first appears is indicated by the leftmost digit(s) in the corresponding reference number.

### DESCRIPTION OF EXAMPLE EMBODIMENTS

1. Overview

An aspect of the present invention enables a user to be provided enhanced information when a pointing device points to a specific area in a graphical user interface being displayed on a display screen.

In one embodiment, on receiving an indication indicating that the pointing device is pointing to a specific area on the display screen and that an input is received from an input device, a message corresponding to the input and the specific area is displayed on the display screen. On receiving a new input from the input device (with the pointing device pointing to the same specific area), a new message corresponding to the new input and the specific area is then displayed on the display screen.

Further, when the graphical user interface contains various graphical elements displayed on the display screen, a specific area indicated by the pointing device may correspond to the area covered by a specific graphical element on the display screen. The messages are then displayed as tool tips associated with the specific graphical element when the pointing device points to the specific area.

According to another aspect of the present invention, digital processing system maintains a configuration data indicating a message to be displayed corresponding to combinations of inputs and areas. The digital processing system then examines the configuration data to determine the message to be displayed for each combination of input and area, as indicated by the user.

Thus, digital processing system may determine that the above message is to be displayed corresponding to the input and the specific area and that the new message is to be displayed corresponding to the new input and the specific area pointed to by the pointing device based on the configuration data.

According to yet another aspect of the present invention, the configuration data indicates that a software program is to be executed in response to receiving a further input when the pointing device points to the same specific area. Accordingly, on receiving an indication that said further input has been provided using an input device, when the pointing device is pointing to the same specific area, the software program is executed to generate a message. The generated message is then displayed on the display screen as enhanced information.

According to one more aspect of the present invention, the configuration data indicates a default message to be displayed when the pointing device initially points to a specific area. Thus, on receiving a default indication that the pointing device initially points to the specific are, the default message is displayed on the display screen as enhanced information. The indications corresponding to different inputs received from an input device may be received after receiving the default indication.

In one embodiment, the default message, the message, and the new message are displayed at a common area on the display screen at different time instances based on the input received or in the case of the default message, when no input has been received. Further, the default message is replaced by the message upon receiving the input, and the message is replaced by the new message upon receiving the new input.

According to another aspect of the present invention, a subset of cells of a table (containing multiple rows and multiple columns forming a set of cells which includes the subset of cells) is initially displayed on a display screen. On receiving an indication that an input is received from an input device when a pointing device points to a specific cell contained in the subset of cells, data corresponding to an additional set of cells is displayed as a message on the display screen. The addition set of cells is not contained in the subset of cells and may be displaced along with the subset of cells on the display screen.

The additional set of cells may correspond to cells in the same row in which the specific cell is located in the table. The additional set of cell may be displayed as enhanced information since only the subset of cells is initially displayed due to area limitations on the display screen. Alternatively, the additional set of cells may correspond to hidden cells which are not displayed by default.

According to one more aspect of the present invention, a graph containing graph objects is initially displayed on a display screen. On receiving indications that different inputs are received from an input device when a pointing device points to the same graph object, messages corresponding to the different inputs are displayed in a common area in response to the indications. In one embodiment, the displayed messages provide enhanced information in relation to the same graph object.

In one embodiment, the pointing device is a mouse and the input device is a keyboard, with the different inputs corresponding to different sets of keys pressed in the keyboard.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, with other methods, or combining one or more aspects/features described herein, etc. In other instances, well-known structures or operations are not shown in detail to avoid obscuring the features of the invention.

2. Digital Processing System

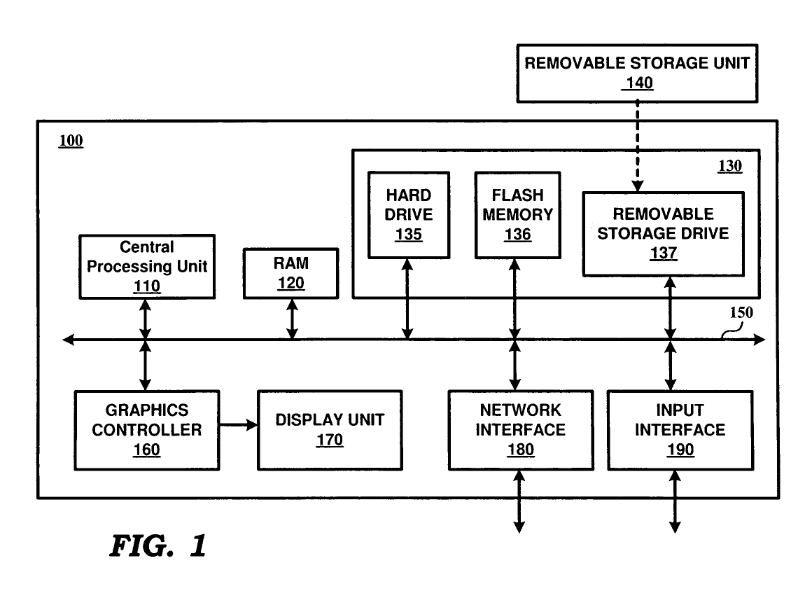

FIG. 1 is a block diagram illustrating the details of digital processing system 100 in which various aspects of the present invention are operative by execution of appropriate software instructions.

Digital processing system 100 may contain one or more processors (such as a central processing unit (CPU) 110), random access memory (RAM) 120, secondary memory 130, graphics controller 150, display unit 170, network interface 180, and input interface 190. All the components except display unit 170 may communicate with each other over communication path 150, which may contain several buses as is well known in the relevant arts. The components of FIG. 1 are described below in further detail.

CPU 110 may execute instructions stored in RAM 120 to provide several features of the present invention. CPU 110 may contain multiple processing units, with each processing unit potentially being designed for a specific task. Alternatively, CPU 110 may contain only a single general-purpose processing unit. RAM 120 may receive instructions from secondary memory 130 using communication path 150.

Graphics controller 150 generates display signals (e.g., in RGB format) to display unit 170 based on data/instructions received from CPU 110. Display unit 170 contains a display screen to display the images defined by the display signals. Multiple graphical elements may be displayed on the display screen to provide suitable graphical user interfaces.

Input interface 190 may correspond to a keyboard and a pointing device (e.g., touch-pad, mouse). It should be appreciated that keyboard represents an example input device (other than the pointing device) using which additional inputs can be provided by a user. However, other input devices can also be used to provide inputs for enhanced information without departing from the scope and spirit of the present invention, as will be apparent to one skilled in the relevant arts by reading the disclosure provided herein.

Network interface 180 provides connectivity to a network (e.g., using Internet Protocol), and may be used to communicate with other systems connected to digital processing system 100. While the features of the invention are described as being provided in a stand-alone computer system merely for illustration, the inputs from the input interface devices can be received from an external system over a network (via network interface 180) as well.

Secondary memory 130 may contain hard drive 135, flash memory 135, and removable storage drive 137. Secondary memory 130 may store the data and software instructions, which enable digital processing system 100 to provide several features in accordance with the present invention.

Some or all of the data and instructions may be provided on removable storage unit 140, and the data and instructions may be read and provided by removable storage drive 137 to CPU 110. Floppy drive, magnetic tape drive, CD-ROM drive, DVD Drive, Flash memory, removable memory chip (PCMCIA Card, EPROM) are examples of such removable storage drive 137.

Removable storage unit 140 may be implemented using medium and storage format compatible with removable storage drive 137 such that removable storage drive 137 can read the data and instructions. Thus, removable storage unit 140 includes a computer readable (storage) medium having stored therein computer software and/or data. However, the computer (or machine, in general) readable medium can be in other forms (e.g., non-removable, random access, etc.).

In this document, the term “computer program product” generally refers to removable storage unit 140 or hard disk installed in hard drive 135. These computer program products are means for providing software to digital processing system 100. CPU 110 may retrieve the software instructions, and execute the instructions to provide various features of the present invention described below.

3. Providing Enhanced Information

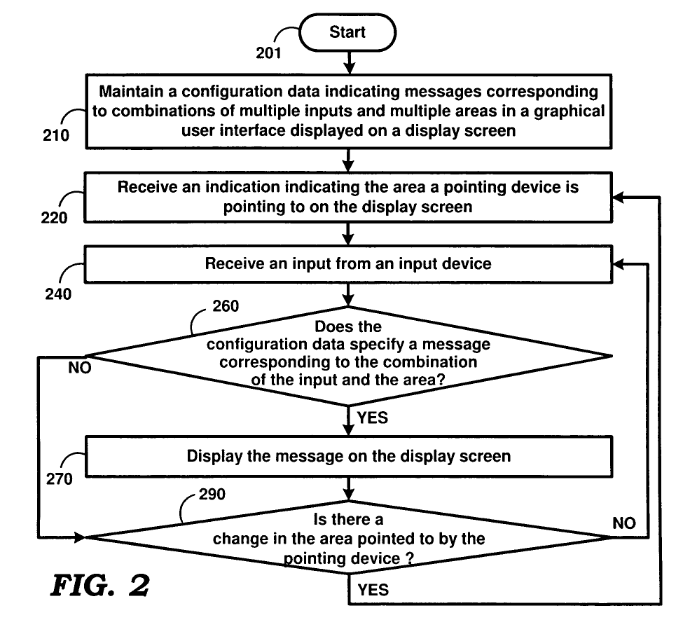

FIG. 2 is a flowchart illustrating the manner in enhanced information is provided when a pointing device points to a specific area in a graphical user interface according to an aspect of the present invention. The flowchart is described with respect to FIG. 1 merely for illustration. However, various features can be implemented in other environments also without departing from the scope and spirit of various aspects of the present invention, as will be apparent to one skilled in the relevant arts by reading the disclosure provided herein.

In addition, some of the steps may be performed in a different sequence than that depicted below, as suited in the specific environment, as will be apparent to one skilled in the relevant arts. Many of such implementations are contemplated to be covered by several aspects of the present invention. The flow chart begins in step 201, in which control immediately passes to step 210.

In step 210, digital processing system 100 maintains a configuration data indicating messages corresponding to combinations of multiple inputs and multiple areas in a graphical user interface displayed on a display screen. The configuration data may be maintained internally (for example in RAM 120 or secondary memory 130) or in an external system such as a database server (not shown) accessible via network interface 180.

In one embodiment described below, the configuration data indicates the messages corresponding to multiple inputs for each of the graphical elements constituting the graphical user interface.

In step 220, digital processing system 100 receives an indication indicating the area a pointing device is pointing to on the display screen. The pointing device may be connected (using a wire/wirelessly) to digital processing system 100 and the indication may be received via input interface 190. In one embodiment, the pointing device corresponds to a mouse (not shown) connected to digital processing system 100.

It may be appreciated that the area indicated by the pointing device may be determined based on the location pointed to by the pointing device. For example, in a scenario that a graphical user interface contains various graphical elements displayed on the display screen, the areas covered by each of the graphical elements on the display screen may be identified as areas that can be indicated by the pointing device. The location pointed to by the pointing device may then be used to determine the specific area indicated by the pointing device.

In one embodiment, when the display screen has a rectangular shape, the location pointed to by the pointing device is received in the form of a pair of co-ordinate numbers (typically in the X and Y directions) in relation to the display screen or the graphical user interface. The X and Y co-ordinates is then checked with each of the identifiable areas on the display screen to determine the area indicated by the pointing device. The checking of whether a location (identified by a pair of numbers) is contained in a specific area is performed in a known way.

It may be appreciated that for other shapes (other than rectangular), the location may be indicated in a known way (for example, as a polar co-ordinate numbers for a circular shape) and the corresponding area indicated may be determined in a corresponding manner as will be apparent to one skilled in the arts.

In step 240, digital processing system 100 receives an input from an input device. Similar to the pointing device, the input device may also be connected (using a wire/wirelessly) to digital processing system 100 and the input may be received via input interface 190.

In one embodiment, the input device corresponds to a keyboard (not shown) connected to digital processing system 100, with the inputs representing respective keys pressed (in the form of scan codes or characters represented by such scan codes). However, the input device can be any other device (other than the pointing device from which the location/area information is indicated).

In step 260, digital processing system 100 determines whether the configuration data specifies a message corresponding to the combination of the input and the area. The messages corresponding to the area represents the different enhanced information available for display when the pointing device points to the area.

In one embodiment, digital processing system 100 first identifies the graphical element corresponding to the area, and then determines whether the configuration data indicates a message corresponding to the input for the identified graphical element. Control passes to step 270 if a message exists for the combination of the input and the area/graphical element and to step 290 otherwise.

In step 270, digital processing system 100 displays the (determined) message on the display screen. The message may be displayed in any convenient manner. In one embodiment, the determined message is displayed as a tool tip associated with the graphical element. A tool tip refers to a small area containing information regarding the graphical element to which a pointing device is currently pointing.

In alternative embodiments, the message may be displayed as status text (appearing in the status bar/panel/area provided by a window, a type of graphical element) or as balloon help (another type of graphical element). Control then passes to step 290.

In step 290, digital processing system 100 checks whether there is a change in the area pointed to by the pointing device. The check may be performed by polling the values of the location from the pointing device via input interface 190. Alternatively, the pointing device may send another indication (via input interface 190) indicating the new location that the pointing device is pointing to. The new location may then be used to determine a new area indicated by the pointing device. The new area is then compared to the area determined in step 220 (based on the previous location of the pointing device) to determine whether a change in area exists.

In the embodiment described below, the new area is used to identify the new graphical element that is being pointed to by the pointing device. As such, a change in area is determined based on whether the new graphical element is different from the graphical element determined in step 260, with a difference indicating of a change in area. Control passes to step 220 if a change in area is determined to exist and to step 240 otherwise.

Thus, the control is passed back to step 220/240 wherein new areas and/or new inputs are received. The corresponding messages are then determined and displayed. The messages may be displayed at a common location or area on the display screen similar to the message displayed in step 270. As such, the new messages may replace older messages displayed in the common location or area. Alternatively, the different messages may be displayed in different formats as will be apparent to one skilled in the art.

It may be appreciated that in the scenario that control passes to step 240 from step 290, the messages displayed corresponding to multiple inputs are associated with the same graphical element. Thus, different enhanced information relating to an area/graphical element may be displayed to the user in response to various inputs, thereby making the user interface more friendly. The description is continued illustrating the manner in which enhanced information is displayed in one embodiment.

4. Displaying Enhanced Information

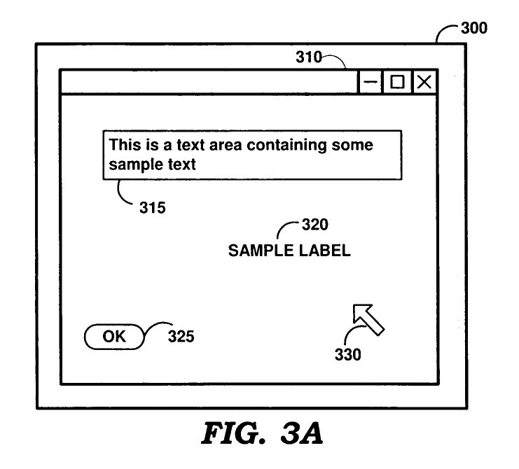

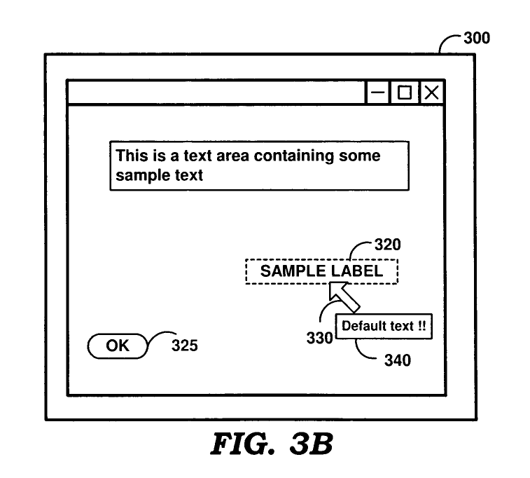

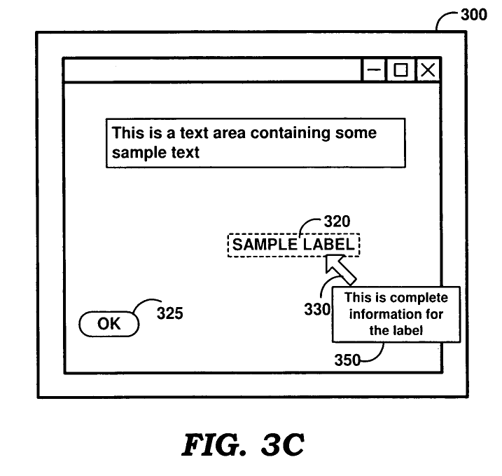

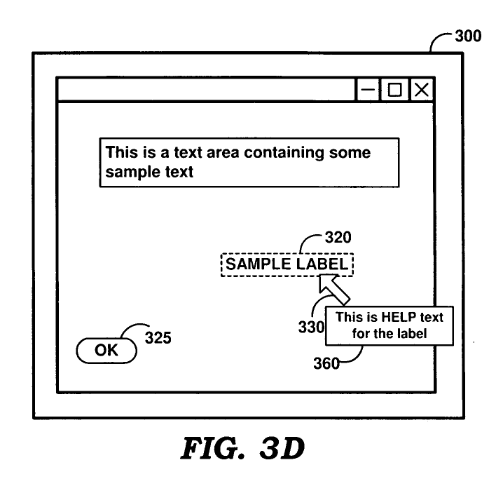

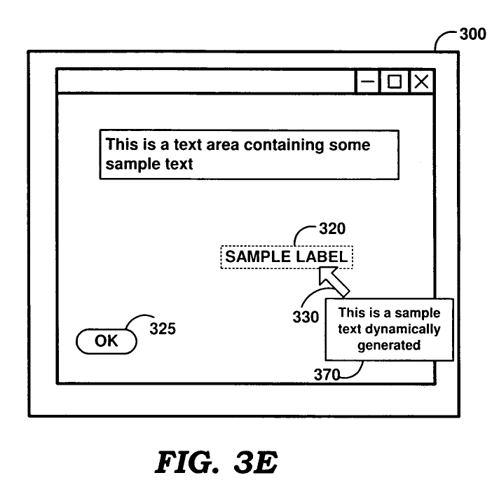

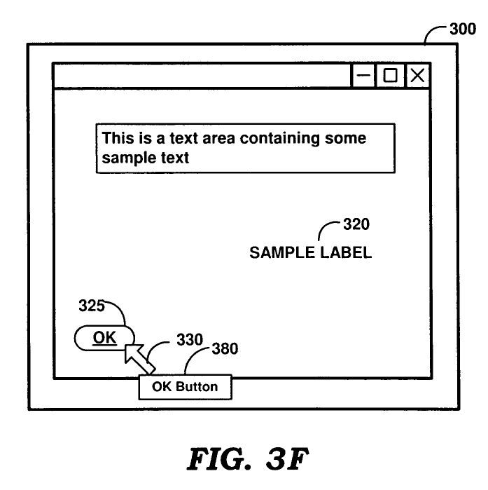

FIGS. 3A-3F together illustrates the manner in which different messages corresponding to different inputs are displayed when a pointing device points to an area (graphical element) in one embodiment. Each of the Figures is described in detail below.

FIG. 3A depicts a portion of a graphical user interface containing different graphical elements in one embodiment. Display area 300 depicts a portion of a graphical user interface containing various graphical elements. Display area 300 is displayed on a display screen provided on display unit 170, and a user provides location/inputs (described below) using pointing/input devices via input interface 190.

Display area 300 is shown containing the graphical element window 310, which represents an interface provided by an application (executing in digital processing system 100) to enable users to interact with (provide inputs to and/or view outputs from) the application.

Window 310, in turn, is shown containing various graphical elements such as text field 315 (containing the text “This is a text area containing some sample text”), label 320 (with text “SAMPLE LABEL” and button 325 (with text “OK”). Text field 315 enables a user to specify textual information to be used by the application, while label 310 enables the application to display appropriate information to the user. Button 325 enables the user to specify a corresponding action to be performed by the application.

It may be observed that each of the graphical elements occupies a corresponding area of the graphical user interface displayed on the display screen. As such, a pointing device is determined to be pointing to a specific area/graphical element when the location pointed to by the pointing device is located in the area corresponding to the specific graphical element. The graphical element determined to be pointed to by the pointing device is said to be in (or “receive”) focus. Though not shown, it may be appreciated that a graphical element may also be displayed overlapping with other graphical elements, and the graphical element in focus may be determined accordingly.

Arrow 330 represents a graphical element indicating the current location of the pointing device, thereby enabling a user to control and select a desired graphical element using the pointing device. Arrow 330 is shown indicating a location located in the area corresponding to window 310 and as such, window 310 is determined to be the area/graphical element indicated by the pointing device.

The pointing device may be moved (with arrow 330 being displayed corresponding to the movement) to a different location such as a location located in the area corresponding to label 320 as described in detail below.

FIG. 3B depicts a portion of a graphical user interface in which a default message (without receiving an input) is displayed when a pointing device initially points to an area (graphical element) in one embodiment. Each of FIGS. 3B-3F depicts graphical elements similar to the elements shown in FIG. 3A and as such, the description of the individual elements is not included for conciseness.

Arrow 330 is shown indicating a location located in the area corresponding to label 320 and accordingly digital processing system 100 determines that label 320 is being initially indicated by the pointing device. Label 320 is shown with a dotted boundary indicating that the graphical element is in focus, thereby providing a visual feedback to the user.

Text 340 (“Default text!!”) represents a tool tip displayed in response to label 320 receiving focus, that is, when the pointing device initially points to a location located in the area corresponding to label 320. Thus, text 340 represents a (default) message displayed without receiving an input from the input device.

In general, the various graphical elements in a graphical user interface are associated with a corresponding message (during development of the application), which are then displayed as tool tips when the graphical elements are in focus. It may be desirable that additional (different) enhanced information (other than the default message) be displayed associated with the various graphical elements. An aspect of the present invention enables different messages corresponding to different inputs to be displayed as described in detail below.

Each of FIGS. 3C-3E depicts a portion of a graphical user interface in which a message is displayed in response to corresponding inputs received from an input device, when the pointing device points to the same area (graphical element) in one embodiment.

In FIG. 3C, text 350 “This is complete information for the label” represents a message displayed in response to a user providing a corresponding input using an input device (such as pressing the key “A” in a keyboard). Similarly, in FIGS. 3D and 3E, text 360 “This is HELP text for the label” and text 370 “This is a sample text dynamically generated” represent other messages displayed in response to a user providing corresponding inputs such as key “H” and key “Ctrl+F”. The key “Ctrl+F” represents a key combination indicating that the keys “Ctrl” and “F” are pressed simultaneously or as a sequence.

It may be observed that the area pointed to by the pointing device (represented by arrow 330) remains the same in FIGS. 3C-3E, and that text 350, 360, and 370 are displayed when different inputs are received from a user using an input device. It may be appreciated that text 350, 360, and 370 may be configured to provide different (relevant) information associated with label 320.

Further, each of the messages is shown to be replaced by the next message, for example, text 350 is shown as being replaced by text 360, which in turn is replaced by text 370. However, the messages may be displayed simultaneously in different areas on the display screen as will be apparent to one skilled in the relevant arts.

Thus, different enhanced information is provided in response to different inputs from a user, when the area pointed to by a pointing device remains the same in a graphical user interface. Thus, the user-friendliness of the user interface is enhanced. The pointer device may now be moved by the user to another desired area and the corresponding messages may be displayed as described in detail below.

FIG. 3F depicts a portion of a graphical user interface in which a default message is displayed when a pointing device points to another area (graphical element) in one embodiment.

Arrow 330 is shown indicating a location located in the area corresponding to button 325. Accordingly, digital processing system 100 displays the text in button 325 as underlined indicating that the graphical element is in focus. Text 380 (“OK Button”) representing a tool tip (containing the default message) is also displayed. It may be appreciated that different messages (compared to shown in FIGS. 3B-3E) associated with the graphical element button 325 may be displayed when corresponding inputs are received from the user.

Thus, different enhanced information related to various graphical elements constituting a graphical user interface may be provided to a user. It should be appreciated that the enhanced information may be ‘hard-coded’ into the program logic. Alternatively, the enhanced information to be provided is based on a configuration data maintained by a user/developer as described below with examples.

5. Maintaining Configuration Data

In one embodiment, the configuration data is provided in the form of files provided along with an application executing in a runtime environment of digital processing system 100. The application on execution retrieves the configuration data from the properties file and determines the messages to be displayed based on the retrieved data. However, other encoding/formats and conventions may be used for representing the configuration data, as will be apparent to one skilled in the relevant arts by reading the disclosure provided herein.

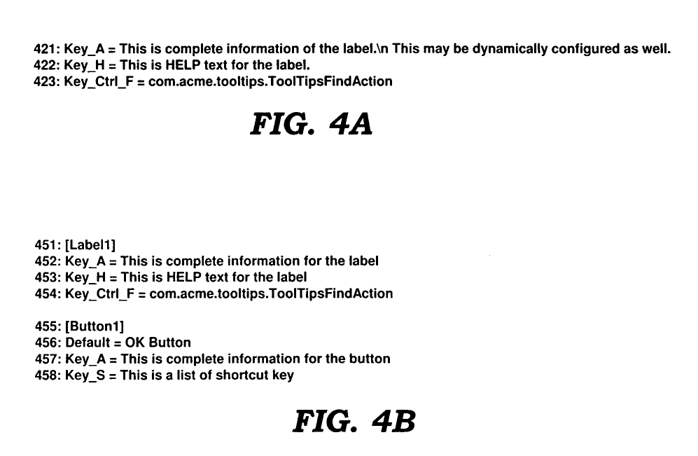

FIG. 4A depicts a portion of a file indicating the messages corresponding to different inputs when a pointing device points to an area (graphical element) in one embodiment. The name of the file (“Label1Bundle.properties”) indicates the name of the graphical element associated with the messages. The description is continued assuming that the name of the file indicates the graphical element label 320 contained in display area 300.

Lines 421-423 depicts the various messages to be displayed corresponding to different inputs when the same graphical element (label 320) is in focus, that is when the same graphical element is pointed to by the pointing device.

In particular, line 421 indicates the message “This is complete information for the label” to be displayed when the key “A” (as indicated by the text “Key_A”) is received as input from a user, when the pointing device points to label 320. It may be observed that the message indicated in line 421 is displayed as a tool tip (as text 350 in FIG. 3C), when a user presses key “A” in a keyboard, when the pointing device points to label 320. Similarly, line 422 indicates a message corresponding to the input “H” which is displayed as text 360 as shown in FIG. 3D.

Line 423 indicates the name of a software program “com.acme.tooltips. ToolTipsFindAction” which is to be invoked when the corresponding key “Ctrl+F” is received as input from a user. The software program to be invoked may correspond to a portion of the application or an external application (or software program) executing in the runtime environment of digital processing system 100.

Thus, on receiving the key “Ctrl+F”, the software program is executed and the result of execution (generally in the form of a text) is displayed as a tool tip (text 370 in FIG. 3E). It should be understood any program logic can be implemented for the software program to generate the message, and the program logic is not demonstrated, in the interest of conciseness.

Thus, the content of the file indicates the messages corresponding to different inputs associated with the same graphical element. It may be appreciated in a scenario that messages corresponding to multiple graphical elements are to be configured, multiple files (each indicating the associated graphical element) may be provided along with the application. Alternatively, a single file specifying the messages associated with different graphical elements may be provided as described in detail below.

FIG. 4B depicts a portion of a file indicating the messages corresponding to different inputs and different areas (graphical elements) in one embodiment.

Each of lines 451 and 455 indicates the name of a graphical element contained in the graphical user interface. The description is continued assuming that the names “Label1” and “Button1” respectively indicates the graphical elements label 320 and button 325 contained in display area 300. The messages (and the corresponding inputs) associated with each of the graphical elements are specified in the subsequent lines. As such, lines 452-454 specify messages associated with label 320 and lines 456-457 specify messages associated with button 325.

Lines 452-454 are similar to lines 421-423 and therefore are not described for conciseness. Line 456 indicates a message “OK Button” that is to be displayed when button 325 is in focus even without an input (as indicated by the keyword “Default”). It may be observed that different messages (lines 452 and 457) associated with different graphical elements may be specified for the same input (“Key_A”). Similarly, messages corresponding to different inputs (such as line 458) for different graphical elements may also be specified.

Thus, on receiving an input when the pointing device points to a specific area (graphical element), digital processing system 100 determines the message based on the received input and the specific area. The determined message may then be displayed on a display screen.

It should be appreciated that the determination of enhanced information can be implemented in various embodiments as a desired combination of one or more of hardware, software and firmware. The description is continued with respect to an embodiment in which various features are operative when software instructions are executed.

6. Software Implementation

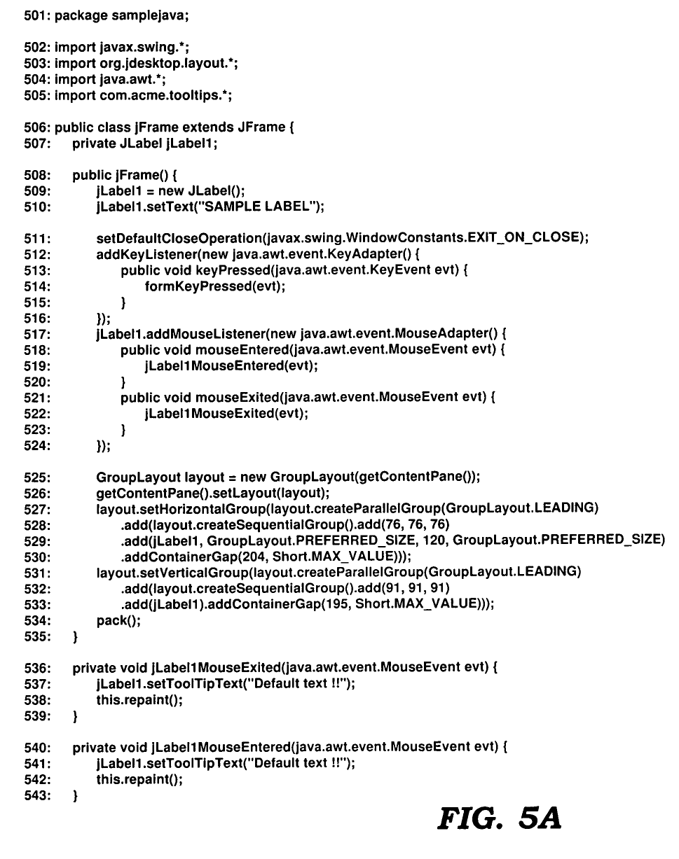

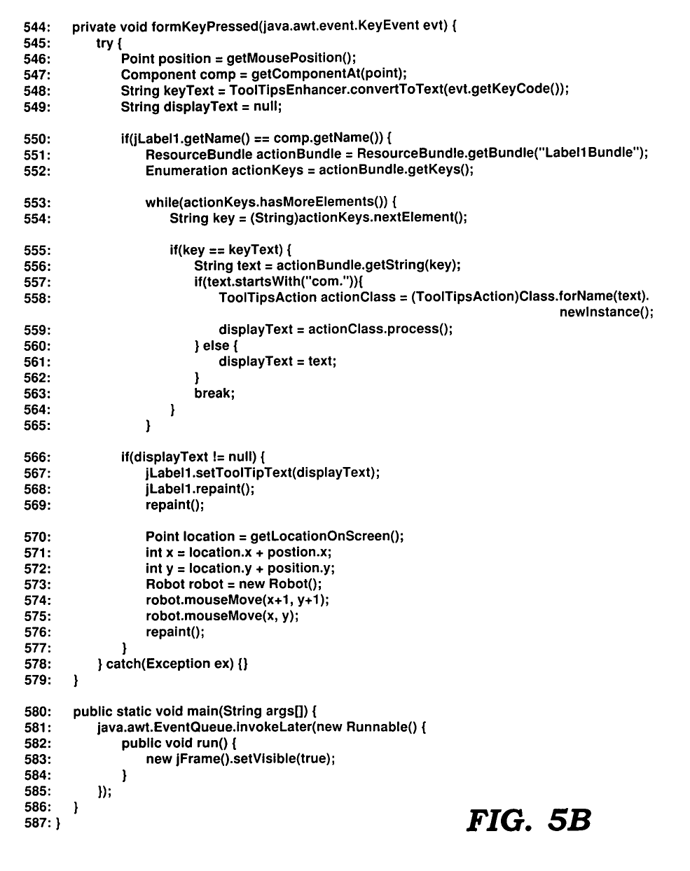

FIGS. 5A and 5B together depicts a portion of a software code (containing software instructions) which on execution provides enhanced information when a pointing device points to a specific area in a graphical user interface in one embodiment. Though the software instructions are shown coded in Java™ programming language, other programming languages and other environments may be used for coding the software code for providing enhanced information.

It may be appreciated that the software code is shown as providing enhanced information (in the form of tool tips) based on the keys (inputs) received from a keyboard (an input device) when the location of a mouse (a pointing device) points to a specific area/graphical element. However, the implementations can be extended to a desired combination of any input device, any pointing device, and any form of enhanced information (including graphics, text, audio, etc.) as will be apparent to one skilled in the relevant arts by reading the disclosure provided herein.

Line 501 depicts the name of the package “samplejava” in which the software code is included, while lines 502-505 depict the names of other packages/classes (such as “javax.swing.*” in line 502) required to execute the software code.

Lines 506-579 depicts software instructions contained in a class named “jframe” (as indicated by line 506) which on execution provides enhanced information when a pointing device points to a specific area in a graphical user interface.

Line 507 depicts a variable “jLabel1” for storing details of a corresponding label (graphical element) contained in the graphical user interface. Similarly, variables for storing details of other graphical elements (one or more of the same/different type) may also be specified at (or after) line 507.

Lines 508-535 depict a function “jframe” executed when an instance of the class “jframe” is created. On execution of the function “jFrame”, various graphical elements constituting a window (another graphical element) are displayed as part of a graphical user interface on a display screen.

In line 509, an instance of a label is created and stored in the variable “jLabel1”. In line 510, the text to be displayed for the label “jLabel1” is set to be “SAMPLE LABEL”. Similarly, other graphical elements (corresponding to the variables specified at line 507) may be created and the details of the graphical elements may be specified at (or after) line 509.

Lines 511-524 depict the actions to be performed when various events associated with the window are received by digital processing system 100. In particular, line 511 indicates that the software code is to be exited when a window “closing” event is received, that is, when a user click on the “X” displayed at the top right corner of the window.

Line 514 indicates that the function “formKeyPressed” is to be invoked when a key event is received, that is, when a key is pressed in a keyboard (an input device). Similarly, lines 519 and 522 indicate that the respective functions “jLabel1MouseEntered” and “jLabel1MouseExited” are to be invoked when the mouse “entered” and “exited” events are received, that is, when the mouse enters and exits the area on the graphical user interface occupied by the graphical element stored in variable “jLabel1”.

In lines 525-533, the graphical element stored in the variable “jLabel1” is added to the window to be displayed. Similarly, other desired graphical elements (created at line 509) stored in corresponding variables (specified at line 507) may also be added to the window to be displayed. In line 534, the window and the graphical elements contained in the window are packed, that is, made ready for display.

It may be observed that the interface displayed is similar to window 310 depicted in FIG. 3A, with only the graphical element label 320 (corresponding to the variable “jLabel1”) contained in it. Though not shown, other desired graphical elements (such as text field 315 and button 325) may also be created and added to the window similar to the manner in which label 320 is added, as described in detail above.

Lines 536-539 depicts a function “jLabel1MouseEntered” which is executed when a mouse “entered” event is received for the graphical element label 320 stored in the variable “jLabel1”. The function may be executed when label 320 receives focus for the first time, for example, when arrow 330 (graphical element corresponding to the mouse) indicates a location located in the area corresponding to label 320 (as shown in FIG. 3B).

On execution of the function “jLabel1MouseEntered”, the value of the tool tip corresponding to label stored in the variable “jLabel1” is set as “Default text!!” (as shown in line 537). Accordingly, the text “Default text!!” is displayed as text 340 in FIG. 3B, when the graphical element label 320 is in focus.

Similarly, lines 540-543 depicts a function “jLabel1MouseExited” which is executed when a mouse “exited” event is received for the graphical element label 320 stored in the variable “jLabel1”. The function may be executed when label 320 loses focus, for example, when arrow 330 indicates a location not located in the area corresponding to label 320 (as shown in FIG. 3F). On execution, the value of the tool tip corresponding to label stored in the variable “jLabel1” is again set as “Default text!!” (as shown in line 541) to reset the value of the tool tip to the default text.

Lines 544-579 depict a function “formKeyPressed” which is executed when a key is received from a keyboard when the location of the mouse is indicated to be in window 310. In line 546, the current location of the mouse (in relation to the graphical element window 310) is retrieved and stored in the variable “position”. In line 547, the graphical element contained in window 310, which is located at the location stored in the variable “position” is determined and stored in the variable “comp”.

As described above, it is assumed that the display screen has a rectangular shape, and as such, the location of the mouse is retrieved as a pair of co-ordinate numbers (typically in X and Y directions) in relation to the display screen or the graphical user interface. The component or the graphical element indicated by the location is then determined. Thus, the area indicated by the mouse (the pointing device) is determined.

In line 548, the value of the key received from a keyboard is retrieved (using the function “evt.getKeyCode”), converted to a corresponding text and stored in variable “keyText”. The conversion to text enables comparison of the received key to the keys/inputs specified in the configuration data. For example, a key “A” received from the keyboard may be converted to the corresponding text “Key_A”. In line 549, a variable “displayText” for storing the value of the text to be displayed is initialized to be “null” (indicating absence of a value/message).

Lines 550-565 are executed only when the name of the component stored in the variable “comp” is similar to the name of the graphical element (label 320) stored in the variable “jLabel1”. Thus, lines 550-565 are executed only when the mouse is determined to be pointing to label 320 (in other words, when label 320 is in focus). Similar blocks of software instructions corresponding to different graphical elements may be added to facilitate enhanced information to be provided when a pointing device (mouse) points to other areas (graphical elements).

In line 551, the configuration data specified for label 320 is accessed. The configuration data is assumed to be in a properties file with name “Label1Bundle.properties”, and as such corresponds to the data depicted in FIG. 4A, as described above. It may be observed that the configuration data in FIG. 4A indicates the messages to be displayed corresponding to keys “Key_A” and “Key_H”, while also indicating the software program to be invoked corresponding to “Key_Ctrl_F”. It may be appreciated that the code may be suitably modified to use the configuration data depicted in FIG. 4B.

In line 552, the values of the keys specified in the configuration data are retrieved. Lines 553-565 are repeated for each of the keys specified in the configuration data. In line 554, the value of a single key is retrieved and compared with the text corresponding to the key received from the keyboard (stored in variable “keyText”). Lines 555-564 are executed only when the value of the single key matches the value stored in variable “keyText”, since a match indicates the presence of a message corresponding to the received key in the configuration data.

In line 556, the message corresponding to the received key is retrieved and stored in variable “text”. In line 557, it is determined whether the message stored in variable “text” starts with the string “com.” (indicating that the message is a software program to be invoked). Lines 558-559 are executed if it is determined that a software program is to be invoked and line 561 otherwise.

Thus, in a scenario that the received key is key “A” or key “H”, line 561 is executed since the messages corresponding to the key text “Key_A” and “Key_H” (as shown in lines 421 and 422) do not start with the string “com.”. If the received key is a combination of the keys “Ctrl” and “F”, lines 558-559 are executed since the message corresponding to the key text “Key_Ctrl_F” (shown in line 423) starts with the string “com.”.

In line 558, an instance of the class (software program) specified by the message (in the variable “text”) is created. In line 559, the function “process” (a pre-defined name) contained in the instance of the created class is invoked and the value returned by the function (representing the message to be displayed) is then stored in the variable “displayText”. In line 561, the message stored in the variable “text” is copied to the variable “displayText”.

Thus, when the received key is a combination of the keys “Ctrl” and “F”, the function “process” in the class “com.acme.tooltips.ToolTipsFindAction” is invoked and the return value (assuming “This is a sample text dynamically generated”) is stored in the variable “displayText”. In the scenario, that the received key is key “A” or key “H”, one of the respective messages “This is complete information for the label” and “This is HELP text for the label” is stored in the variable “displayText”.

In line 566, the value of the variable “displayText” is compared to “null” to determine the presence of a value/message to be displayed. No value is stored in the variable “:displayText” during execution of lines 550-565, if the configuration data does not indicate a message/software program corresponding to the received key or alternatively if an error occurs during execution of the software program indicated by the configuration data. Lines 567-576 are executed only when variable “displayText” contains a message to be displayed.

In lines 567-569, the value of the tool tip of the graphical element (label 320) stored in the variable “jLabel1” is set to the message stored in the variable “displayText”. In lines 570-576, the location of the mouse is moved by one unit in X and Y directions and then moved back to the original location to facilitate the display of the tool tip associated with the graphical element.

In the above scenario, when the received key is key “A” or key “H”, the corresponding messages are displayed as tool tips shown as respective text 350 in FIG. 3C and text 360 in FIG. 3D. If the received key is a combination of the keys “Ctrl” and “F”, the text “This is a sample text dynamically generated” is displayed as the tool tip shown as text 370 in FIG. 3E.

Lines 580-587 depicts a function that invokes execution of the class “jFrame” by creating an instance of the class for creating the window and then setting the created window to be visible on the display screen (as indicated by the instruction “new jFrame( ).setVisible(true);” in line 583).

Thus, the software code depicted in FIGS. 5A and 5B on execution by digital processing system 100 enables enhanced information to be provided when a pointing device points to a specific area in a graphical user interface.

Though the above description is provided with respect to a stand-alone digital processing system, it may be appreciated that the features can be implemented in relation to interfaces (“web based user interfaces”) used with web applications. Accordingly, the description is continued illustrating the manner in which enhanced information is provided for web-based user interfaces in one alternative embodiment.

7. Providing Enhanced Information for Web-based User Interfaces

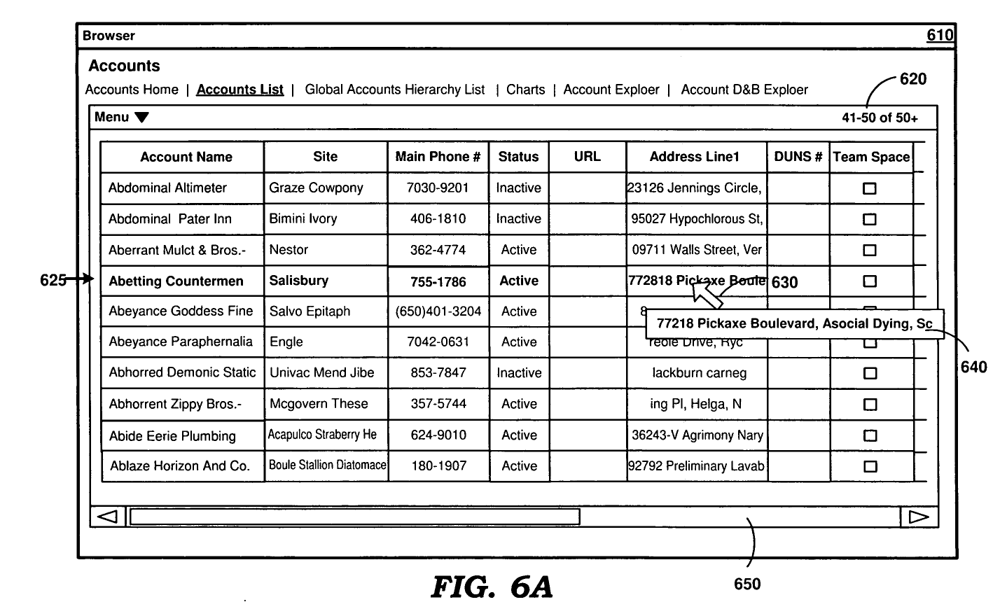

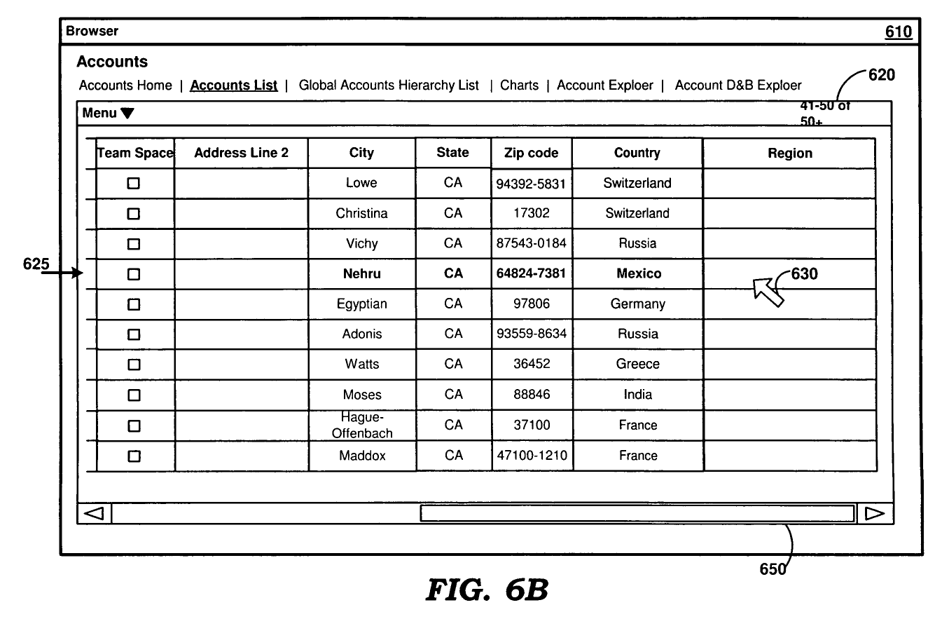

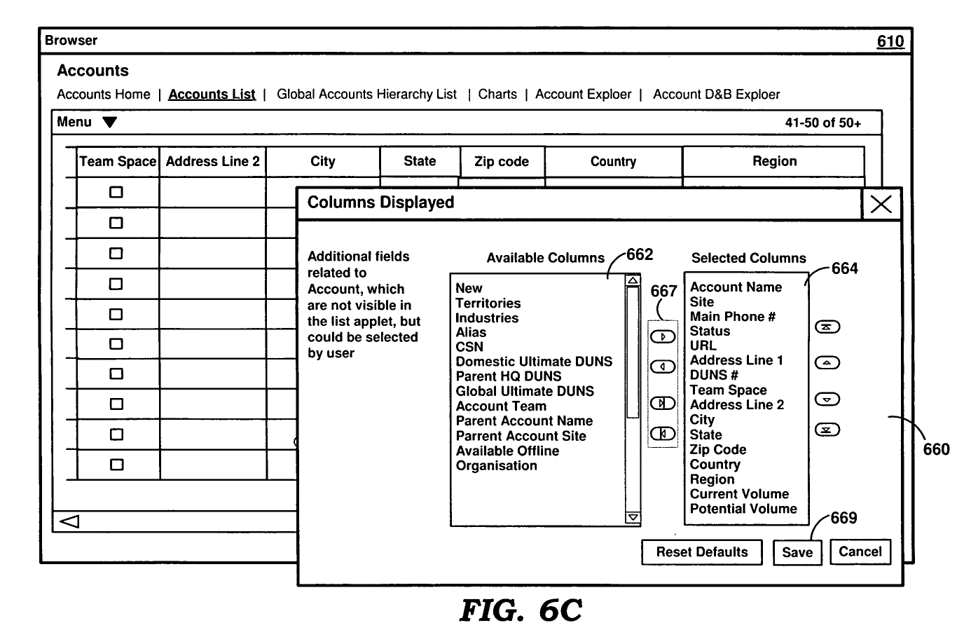

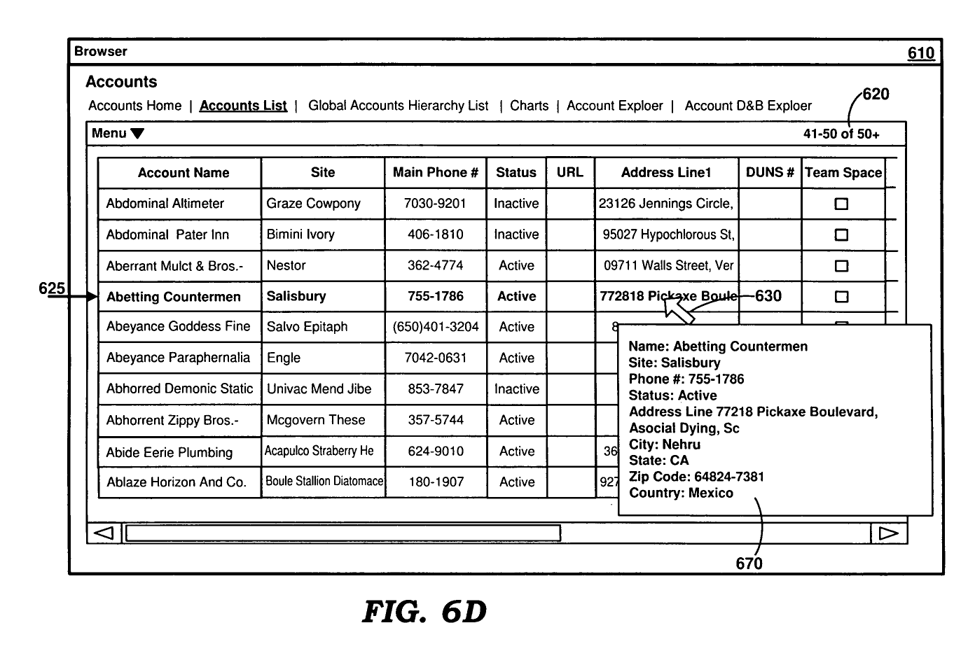

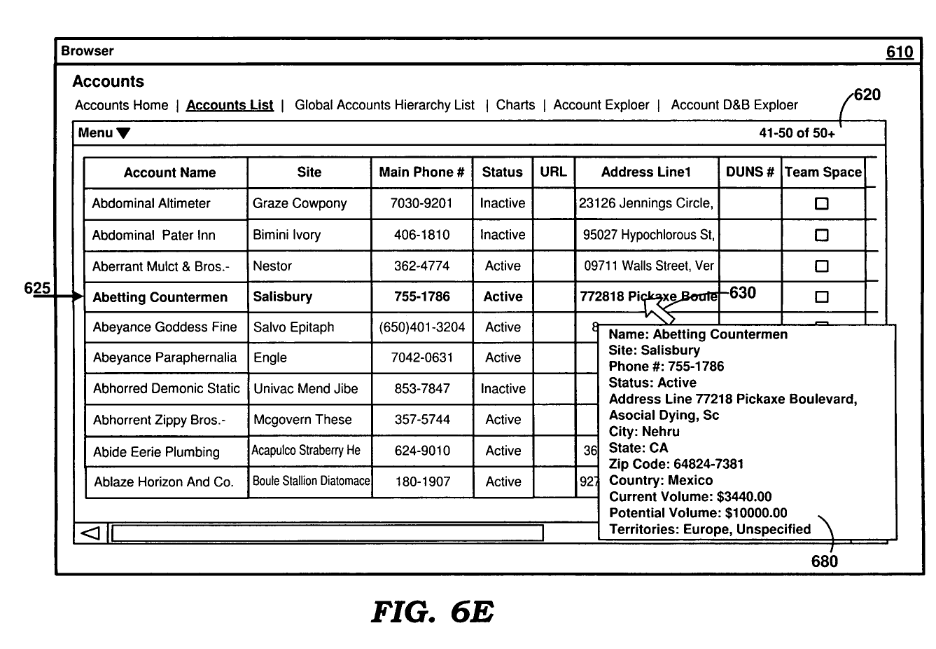

In one embodiment, digital processing system 100 provides a runtime environment in which a browser application such as Internet Explorer 6.0 available from Microsoft Corporation is executed. The browser application is designed to send user requests (e.g., in the form of URLs) to a server system (not shown) via network interface 180. The browser application then receives the responses from the server system in the form of hypertext markup language (HTML) data, which is then processed to generate the corresponding web-based user interfaces (such as FIGS. 6A-6E) on a display screen.

FIGS. 6A-6E together illustrates the manner in which different messages corresponding to different inputs are displayed when a pointing device points to an area (graphical element) in a web-based user interface in one embodiment. Each of the Figures is described in detail below.

FIG. 6A depicts a portion of a web-based user interface containing information of interest in one embodiment. Display area 610 depicts a portion of a web-based user interface (generated by the browser application) containing various graphical elements depicting information of interest. Display area 610 may be displayed on a display screen provided on display unit 170, and a user provides locations/inputs (described below) using pointing/input devices via input interface 190.

Table 620 depicts information of interest (the details of various accounts) displayed in the form of rows and columns such as “Account Name”, “Site”, “Address Line 1” etc. Row 625 depicts a specific row of interest indicating an account with name “Abetting Countermen” located at the site “Salisbury” and other relevant information.

The rows and columns may be viewed as forming multiple cells/areas which can be indicated by a pointing device, with each cell containing a corresponding value. For example, the area represented as the intersection of row 625 and the column labeled “Name” may be viewed as a cell with the corresponding value of “Abetting Countermen”. It may be observed that the values contained in some of the cells (such as the cells in the “Address Line 1” column) are not displayed completely due to lack of space on the display screen.

Arrow 630 represents a graphical element indicating the current location of the pointing device, thereby enabling a user to control and select a desired area/cell using the pointing device. Arrow 630 is shown indicating the cell at the intersection of row 625 and the column labeled “Address Line 1”.

Text 640 represents the default tool tip displayed when a pointing device points to a specific area/cell, which is the complete value of the cell. Accordingly, text 640 indicates the complete value “77218 Pickaxe Boulevard, Asocial Dying, Sc” of the cell at the intersection of the column “Address Line 1” with row 625.

It may be observed that scroll bar 650 indicates the presence of additional information (more columns/cells of table 620 and row 625) existing in the horizontal direction (to the right), which is currently not being displayed on the display screen. Thus, a user may be required to scroll horizontally in the right direction using scroll bar 650 (or appropriate inputs) to view the additional information as described below.

FIG. 6B depicts a portion of a web-based user interface containing additional information of interest in one embodiment. Each of FIGS. 6B-6E depicts graphical elements similar to the elements shown in FIG. 6A and as such, the description of the individual elements is not included for conciseness.

Table 620 currently depicts additional information of interest (the additional details of various accounts) displayed in the form of rows and new columns such as “City”, “State”, “Country”, etc. Row 625 currently depicts additional information (cells) such as the city “Nehru” and the country “Mexico” of the account with name “Abetting Countermen”. The previous information (shown in FIG. 6A) may be viewed by scrolling horizontally in the left direction by using scroll bar 650 (or appropriate inputs).

It may be appreciated that further information may also be provided in table 620. Such information may be hidden in the display and as such, a user may be required to select explicitly the hidden information (columns/cells) to be further displayed as described in detail below.

FIG. 6C depicts a portion of a web-based user interface enabling a user to select hidden information of interest to be displayed in one embodiment. Display area 660 depicts an interface displayed in response to an indication from a user that the columns currently being displayed are to be modified. The indication may be received when the user selects/clicks on an appropriate button/graphical element provided in the graphical user interface.

Display area 660 is shown containing an available columns list 662 indicating the hidden columns (information) available for display and a selected columns list 664 indicating the currently displayed columns (information). As such, the user may select the hidden information of interest for display by selecting the appropriate hidden columns.

Thus, a user may add/remove columns of interest from selected columns list 664 using the button provided in panel 667. After selecting the desired columns (information) to be displayed, the user may click/select button 669 (labeled “Save”) to indicate completion of selection. It may be observed that the hidden columns “Current Volume” and “Potential Volume” are shown as being selected for display.

On receiving such an indication, the browser application may send a request (in the form of a URL) to the server system indicating the columns/cells selected by the user. The request may indicate all the columns selected for display or alternatively only the newly selected columns. On receiving a corresponding response containing the relevant information (in the form of HTML data), the browser application generates/displays the information in display area 610 (in the form of table 620) similar to FIGS. 6A and 6B.

It may be observed that the user is required to scroll horizontally or select desired columns to view additional/hidden information of interest. It may be desirable that the additional/hidden information be provided to the user with alternative approaches. An aspect of the present invention enables the display of enhanced information when a pointing device is pointing to a specific area (row) as described below with examples.

Each of FIGS. 6D and 6E depicts a portion of a web-based user interface in which additional/hidden information is displayed in response to corresponding inputs received from an input device, when the pointing device points to the same area (cell) in one embodiment.

In FIG. 6D, text 670 represents additional information displayed in response to a user providing a corresponding input using an input device (such as pressing the key “R” in a keyboard). It may be observed that text 670 displays the information corresponding to all the columns/cells of row 625 (shown in FIG. 6A and 6B) of table 620, while arrow 630 still points to the same cell as in FIG. 6A.

Similarly, in FIG. 6E, text 680 represents hidden information displayed in response to a user providing a corresponding input using an input device (such as pressing the key “X” in a keyboard). It may be observed that text 680 displays the information corresponding to hidden columns/cells such as “Current Volume” (shown in FIG. 6C) of row 625 of table 620, while arrow 630 still points to the same cell as in FIG. 6A.

In one embodiment, the response received by the browser application (for a user request) contains software code (for example, encoded in Javascript™) designed to identify keys received from a keyboard and the row/column identifiers (representing the location/area) pointed to by the mouse (the pointing device). The software code on execution by the browser application, identifies the action to be performed (such as retrieving the additional/hidden information) based on a specific combination of input and row.

The software code then generates a request in the form of a URL containing a pre-specified destination, the present row/column/cell identifiers (pointed by the pointed device) and a keyword (such a “ROW” or “HIDDEN”) representing the action to be performed. An appropriate application on the server system (e.g., identified by the pre-specified destination) then generates the additional/hidden information corresponding to the present row/column/cell identifiers as a response to the request.

On receiving the corresponding information in response to the request, the software code executed by the browser application generates a new tool tip or modifies the text corresponding to the previously displayed tool tip, thereby causing the browser application to display the relevant information on the display screen as shown in FIGS. 6D and 6E.

It may be appreciated that, in alternate embodiments, digital processing system 100 may send requests to a server system indicating the specific area (cell) that the pointing device is pointing to and the specific input received from the input device. Digital processing system 100 may then display the information received in response to the requests in an appropriate manner.

It may be further appreciated that though the information is shown displayed in the form of tool tips in the above FIGS. 6D and 6E, in alternative embodiments, the information may be displayed in any convenient manner. The description is continued illustrating the manner in which the information is displayed in a common area on the web-based user interface in one embodiment.

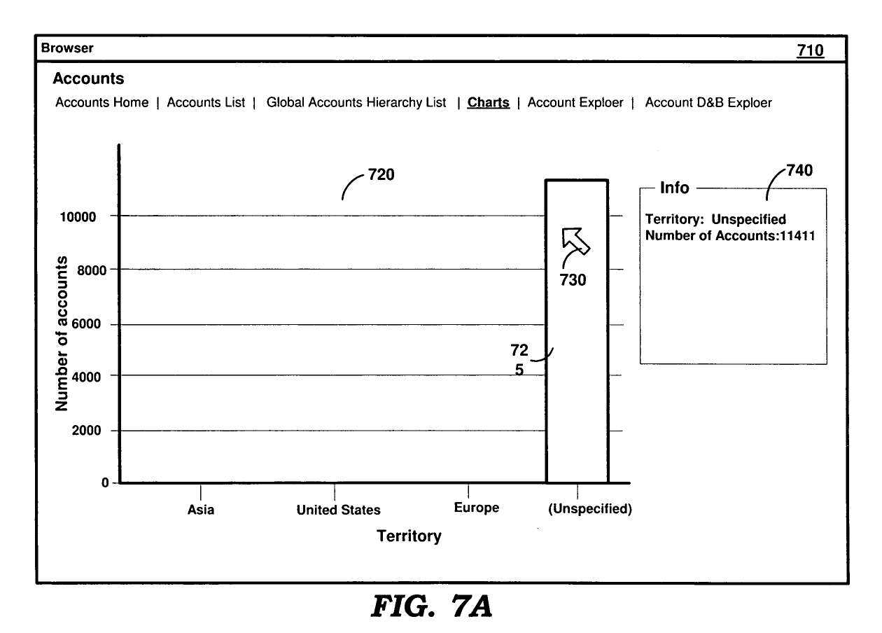

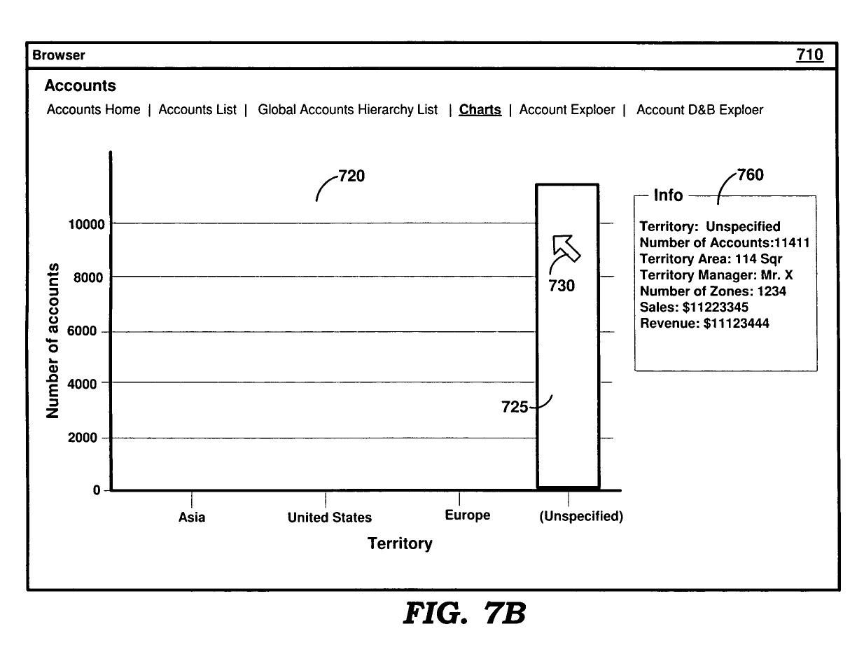

FIG. 7A depicts a portion of a web-based user interface containing information of interest displayed in a visual manner (in the form of a graph containing graph objects) in one embodiment. Display area 710 depicts a portion of a web-based user interface containing various graphical elements depicting information of interest in a visual manner. Display area 710 is generated and displayed similar to display area 610 by the browser application.

Graph 720 depicts information of interest (the number of accounts in each territory) in a visual manner. Graph 720 is shown containing various graph objects such as X-axis (representing territories), Y-axis (representing number of accounts), bars (representing information of interest), gird lines, etc.

Bar 725 represents a graph object indicating specific information of interest, that is, the number of accounts associated with “unspecified” territories. Arrow 730 represents a graphical element indicating the current location of the pointing device. Arrow 730 is shown indicating the area covered by bar 725 on the display screen and as such bar 725 is indicated to be the graphical element in focus.

Display area 740 represents a common area in which different messages corresponding to different inputs (or no input in the case of the default message) are displayed. Display area 740 is shown containing a default text (containing the name of the territory and the number of accounts) displayed when a pointing device points to a specific location (bar 725). It may be desirable that other enhanced information about the territory be provided as described in detail below.

FIG. 7B depicts a portion of a web-based user interface in which additional information is displayed in a visual manner in response to corresponding inputs received from an input device, when the pointing device points to the same area (graph object) in one embodiment.

Display area 760 represents the common area displaying additional information in response to a user providing a corresponding input using an input device (such as pressing the key “X” in a keyboard). It may be observed that display area 760 currently displays additional information about the territory such as the “Territory Area”, “Number of Zones” etc. while arrow 730 still points to the same graph object, bar 725.

It may be appreciated that digital processing system 100 may send requests to a server system indicating the information to be retrieved based on the input and then display the retrieved information received in response to the requests.

Thus, enhanced information is provided for web-based user interfaces by displaying different messages corresponding to different inputs when a pointing device points to an area (graphical element) in a web-based user interface.

9. Conclusion

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

It should be understood that the figures and/or screen shots illustrated in the attachments highlighting the functionality and advantages of the present invention are presented for example purposes only. The present invention is sufficiently flexible and configurable, such that it may be utilized in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

1. A method of providing enhanced information when a pointing device is used in relation to a graphical user interface, said graphical user interface being displayed on a display screen, said method comprising:
receiving a first indication indicating that a first input is received from an input device when said pointing device points to a first area on said display screen;
displaying a first message on said display screen; receiving a second indication that a second input is received from said input device when said pointing device points to said first area; and
displaying a second message on said display screen, wherein said second message is not identical to said first message,
wherein said first message and said second message contain respective enhanced information related to a graphical element present in said first area.

2. The method of claim 1, further comprising:
maintaining a configuration data indicating a corresponding one of a set of messages to be displayed for a corresponding combination of one of a set of inputs and one of a set of areas; examining said configuration data to determine the message to be displayed for each combination of input and area,
wherein said first message is determined corresponding to said first input and said first area, and said second message is determined corresponding to said second input and said first area,
wherein said first message and said second message are contained in said set of messages.

3. The method of claim 2, wherein said configuration data indicates that a software program is to be executed in response to receiving a third input when said pointing device points to said first area, said method further comprising:
receiving a third indication that said third input is received from said input device when said pointing device points to said first area;
executing said software program in response to receiving said third indication to generate a third message; and
displaying said third message on said display screen as said enhanced information related to said graphical element.

4. The method of claim 2, wherein said configuration data indicates a default message to be displayed when said pointing device initially points to said first area, said method further comprising:
receiving a fourth indication that said pointing device initially points to said first area; and
displaying said default message on said display screen as said enhanced information related to said graphical element,
wherein said first indication and said second indication are received after said fourth indication.

5. The method of claim 4, wherein said displaying displays said default message, said first message and said second message at a common area on said display screen at different time instances, wherein said default message is replaced by said first message upon receiving said first indication, and said first message is replaced by said second message upon receiving said second indication.

6. The method of claim 5, wherein said displaying displays said first message and said second message as a respective tool tip associated with said graphical element when said pointing device points to said first area.

7. The method of claim 1, wherein said pointing device comprises a mouse and said input device comprises a keyboard, wherein said first input and second input corresponds respectively to a first set of keys and a second set of keys pressed in said keyboard.

8. The method of claim 7, further comprising:
displaying a subset of cells of a table on said display screen, wherein said table contains a plurality of rows and a plurality of columns forming a plurality of cells including said subset of cells, wherein said first area corresponds to the area covered by a first cell contained in said subset of cells; and
displaying data corresponding to an additional set of cells as said first message in response to said first indication, wherein said first message is displayed in addition to said subset of cells on said display screen, wherein each of said additional set of cells is not contained in said subset of cells.

9. The method of claim 8, wherein said additional set of cells correspond to the same row in which said first cell is located in said table.

10. The method of claim 8, wherein only said subset of cells is initially displayed due to area limitations on said display screen.

11. The method of claim 8, wherein said additional set of cells comprises hidden cells which are not displayed by default.

12. The method of claim 7, further comprising:
displaying a graph containing a plurality of graph objects, wherein said first area corresponds to the area covered by a first graph object contained in said plurality of graph objects,
wherein said first message is displayed in a common area in response to said first indication and said second message is also displayed in said common area in response to said second indication, wherein said first message and said second message provide said enhanced information in relation to said first graph object.

13. A machine readable medium storing one or more sequences of instructions for causing a system to providing enhanced information when a pointing device is used in relation to a graphical user interface, said graphical interface comprising a plurality of graphical elements being displayed on a display screen, wherein execution of said one or more sequences of instructions by one or more processors contained in said system causes said system to perform the actions of:
receiving an indication that a graphical element is initially being pointed to by said pointing device, wherein said graphical element is contained in said plurality of graphical elements;
displaying a default message on said display screen; receiving a first indication that a first set of keys is pressed in a keyboard when said pointing device points to said graphical element;
displaying a first message on said display screen, wherein said first message is not identical to said default message;
receiving a second indication that a second set of keys is pressed in said keyboard when said pointing device points to said graphical element; and
displaying a second message on said display screen, wherein said second message is not identical to said first message and said default message,
wherein said default message, said first message and said second message contain enhanced information related to said graphical element.

14. The machine readable medium of claim 13, further comprising one or more instructions for:
maintaining a configuration data indicating a corresponding one of a set of default message to be displayed when said pointing device initially points to each of said plurality of graphical elements, and a corresponding one of a set of messages to be displayed for a corresponding one of a plurality of sets of keys when said pointing device points to each of said plurality of graphical elements;
examining said configuration data to determine the message to be displayed for each combination of set of keys and graphical element,
wherein said default message is determined corresponding to said graphical element, and said first message and said second message are respectively determined corresponding to said first set of keys and said second set of keys in combination with said graphical element,
wherein said default message is contained in said set of default messages and said first message and second message are contained in a set of messages corresponding to said graphical element.

15. The machine readable medium of claim 14, wherein said configuration data indicates that a software program is to be executed corresponding to a third set of keys when said pointing device points to said graphical element, said method further comprising one or more instructions for:
receiving a third indication that said third set of keys is pressed in said keyboard when said pointing device points to said graphical element;
executing said software program in response to receiving said third indication to generate a third message; and
displaying said third message on said display screen as said enhanced information related to said graphical element.

16. The machine readable medium of claim 14, wherein said displaying displays said default message, said first message and said second message at a common area on said display screen at different time instances, wherein said default message is replaced by said first message upon receiving said first indication, wherein said first message is replaced by said second message upon receiving said second indication.

17. The machine readable medium of claim 16, wherein said displaying displays said default message, said first message and said second message as a respective tool tip associated with said graphical element when said pointing device points to said graphical element.

18. A digital processing system comprising:
a display screen to display a graphical user interface comprising a plurality of graphical elements;
a pointing device to point to a first graphical element on said display screen in relation to said graphical user interface;
a keyboard to provide a first input and a second input when said pointing device points to said first graphical element; and
a processor to display a first message on said display screen in response to said first input and to display a second message on said display screen in response to said second input, when said pointing device points to said first graphical element,
wherein said first message and said second message contains enhanced information related to said first graphical element.

19. The digital processing system of claim 18, further comprising:
a memory to store a configuration data indicating a corresponding one of a set of messages for a corresponding combination of one of a set of inputs and one of said plurality of graphical elements,
wherein said processor examines said configuration data to determine the message for each combination of input and graphical element,
wherein said first message is determined corresponding to said first input and said first graphical element, and said second message is determined corresponding to said second input and said first graphical element,
wherein said first message and said second message are contained in said set of messages.

20. The digital processing system of claim 19, wherein said first message and said second message are displayed at a common area on said display screen at different time instances, wherein said first message is replaced by said second message upon receiving said second input.

21. The digital processing system of claim 19, wherein said configuration data indicates that a software program is to be executed in response to receiving a third input from said keyboard when said pointing device points to said first graphical element,
wherein said processor executes said software program in response to said third input received from said keyboard to generate a third message,
wherein said processor displays said third message on said display screen as a response to said third input, wherein said third message contains enhanced information related to said first graphical element.
